(19) United States
(12) Patent Application Publication
(10) Pub. No.: US 2024/0243446 A1
(43) Pub. Date: Jul. 18, 2024

(54) BATTERY MODULE

(71) Applicants: Panasonic Holdings Corporation, Osaka (JP); Sanyo Electric Co., Ltd., Osaka (JP); TOYOTA JIDOSHA KABUSHIKI KAISHA, Aichi-Ken (JP)

(72) Inventors: Shunsuke UEGAKI, Nara (JP); Tassuya KAWASAKI, Nara (JP); Ryoichi WAKIMOTO, Hyogo (JP); Nobuhiro YAMADA, Toyata-shi, Aichi-ken (JP); Yuji YAMASHITA, Toyota-shi, Aichi-ken (JP); Hiroki NAGAI, Ama-gun, Aichi-ken (JP)

(21) Appl. No.: 17/913,818

(22) PCT Filed: Mar. 23, 2021
(86) PCT No.: PCT/JP2021/011878

§ 371 Date: Mar. 29, 2024

(30) Foreign Application Priority Data
Mar. 24, 2020 (JP) 2020-051968

(51) Int. Cl. H01M 50/552; H01M 50/204; H01M 50/503; H01M 50/516

(52) U.S. Cl. CPC H01M 50/552; H01M 50/204; H01M 50/503; H01M 50/516

(57) ABSTRACT

A battery module comprises a battery laminate in which a plurality of batteries each having an output terminal 12 are arrayed, and a busbar 4 that is joined to the output terminal 12 of each battery and electrically connects the plurality of batteries. The output terminal 12 has a probe mark 18 on the surface facing the busbar 4, and the busbar 4 has a recess 22 facing the probe mark 18.

### TECHNICAL FIELD

The present invention relates to a battery module.

### BACKGROUND ART

One known power source for which a high output voltage is required (e.g., a power supply for a vehicle, etc.) is a battery module in which a plurality of secondary batteries are electrically connected. In a battery module, adjacent batteries are electrically connected via a bus bar. Meanwhile, in a process of manufacturing a secondary battery, a probe is brought into contact with the output terminal of the secondary battery to charge or discharge the secondary battery or to conduct an inspection, as disclosed in, for example, patent literature 1.
[Patent Literature 1] JP2004-319334

### SUMMARY OF INVENTION

### Technical Problem

To charge or discharge the battery or to conduct an inspection accurately and safely, it is desirable to reduce the contact resistance between the output terminal and the probe. One known method to reduce the contact resistance is to cause the probe to bite into the output terminal by pressing the probe against the output terminal with a strong force, thereby removing the resistance of an oxide film on the terminal surface or increasing the contact area. If the probe is pressed against the output terminal, however, a probe trace may remain on the output terminal. The probe trace that remains on the output terminal may cause reduction in the reliability of connection between the output terminal and the bus bar.

The present disclosure addresses the above-described issues, and a purpose thereof is to provide a technology of increasing the reliability of connection between the output terminal of a battery and the bus bar.

### Solution to Problem

An embodiment of the present disclosure relates to a battery module. The battery module includes: a battery stack in which a plurality of batteries each having an output terminal are arranged; and a bus bar bonded to the output terminal of each battery and electrically connecting the plurality of batteries. The output terminal has a probe trace on a surface that faces the bus bar, and the bus bar has a concave part that faces the probe trace.

Another embodiment of the present disclosure also relates to a battery module. The battery module includes: a battery stack in which a plurality of batteries each having an output terminal are arranged; and a bus bar bonded to the output terminal of each battery and electrically connecting the plurality of batteries. The output terminal has a bonding surface bonded to the bus bar, a concave part concave with respect to the bonding surface in a direction away from the bus bar, and a probe trace accommodated in the concave part.

Optional combinations of the aforementioned constituting elements, and implementations of the present disclosure in the form of methods, apparatuses, systems, etc. may also be practiced as additional modes of the present disclosure.

### Advantageous Effects of Invention

According to the present disclosure, the reliability of connection between the output terminal of a battery and the bus bar can be increased.

### BRIEF DESCRIPTION OF DRAWINGS

FIG. 1 is a perspective view of a part of a battery module according to embodiment 1;

FIG. 2 is a cross-sectional view of a part of the output terminal and the bus bar included in the battery module according to embodiment 1;

FIG. 3 is a cross-sectional view of a part of the output terminal and the bus bar included in the battery module according to variation 1; and

FIG. 4 is a cross-sectional view of a part of the output terminal and the bus bar included in the battery module according to embodiment 2.

### DESCRIPTION OF EMBODIMENTS

Hereinafter, the present disclosure will be described based on preferred embodiments with reference to the accompanying drawings. The embodiments are not intended to limit the scope of the present disclosure but exemplify the present disclosure. Not all of the features and the combinations thereof described in the embodiments are necessarily essential to the present disclosure. Identical or like constituting elements, members, processes shown in the drawings are represented by identical symbols and a duplicate description will be omitted as appropriate. The scales and shapes shown in the figures are defined for convenience's sake to make the explanation easy and shall not be interpreted limitatively unless otherwise specified. Terms like “first”, “second”, etc. used in the specification and claims do not indicate an order or importance by any means unless specified otherwise and are used to distinguish a certain feature from the others. Those of the members that are not important in describing the embodiment are omitted from the drawings.

### Embodiment 1

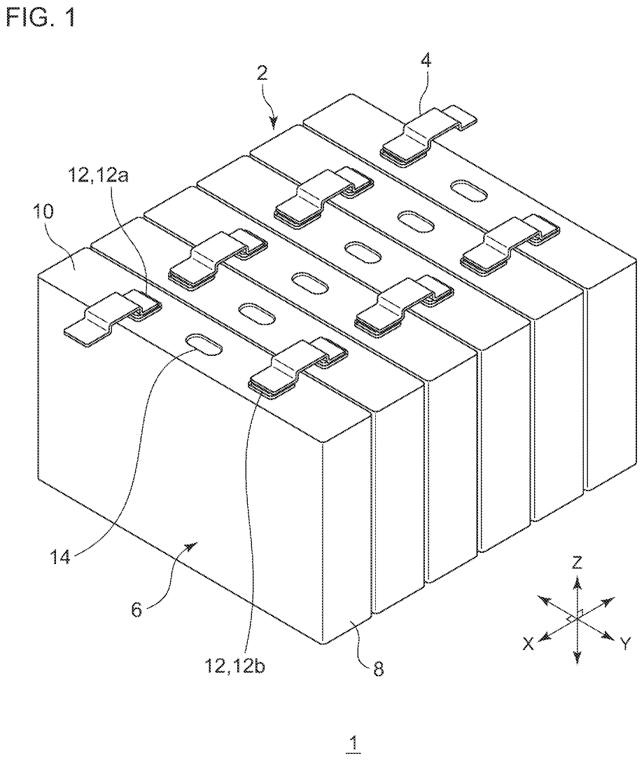

FIG. 1 is a perspective view of a part of a battery module according to embodiment 1. The battery module 1 includes a battery stack 2 and a bus bar 4. The battery stack 2 includes a plurality of batteries 6 arranged. Each battery 6 is a primary battery or a chargeable secondary battery such as a lithium primary battery, a lithium-ion battery, a nickel-hydrogen battery, and a nickel-cadmium battery. Each battery 6 is a so-called rectangular battery and includes an exterior can 8 having a flat, rectangular shape. A substantially rectangular opening is provided in one surface of the exterior can 8, and an electrode body, an electrolyte, etc. are housed in the exterior can 8 via the opening. A sealing plate 10 having a substantially rectangular shape that blocks the opening is fitted to the opening of the exterior can 8.

A pair of output terminals 12 are provided in the sealing plate 10. More specifically, an anode terminal 12a is provided toward one end in the longitudinal direction, and a cathode terminal 12b is provided toward the other end. Hereinafter, the anode terminal 12a and the cathode terminal 12b will be collectively referred to as output terminals 12 if there is no need to distinguish between the polarities of the pair of output terminals 12.

The exterior can 8, the sealing plate 10, and the output terminal 12 are electric conductors and are made of a metal such as aluminum, iron, stainless. The exterior can 8 and the sealing plate 10 are bonded by, for example, laser welding. Each output termina 12 is inserted into a through hole formed in the sealing plate 10. An insulative sealing member is interposed between each output terminal 12 and each through hole. The exterior can 8 may be coated with an insulative film (not shown) such as a shrinkable tube. Further, the exterior can 8 and the sealing plate 10 may be made of an insulative resin.

Each battery 6 includes a valve part 14 in the sealing plate 10. The valve part 14 is provided between the pair of output terminals 12 in the sealing plate 10. The valve part 14 is also called a safety valve. The valve part 14 is configured to open to discharge the gas inside the battery 6 when the internal pressure in the battery 6 is increased to a predetermined value or higher. The valve part 14 is comprised of a small-thickness part provided in a part of the sealing plate 10 and having a thickness smaller than the other parts and an linear groove formed on the surface of the small-thickness part. In this configuration, an increase in the internal pressure in the battery 6 tears the small-thickness part around the groove to cause the valve part 14 to open.

The plurality of batteries 6 are arranged at predetermined intervals such that the principal surfaces of adjacent batteries 6 face each other. In this embodiment, the batteries 6 are arranged in the horizontal direction. Hereinafter, the direction in which the batteries 6 are arranged will be defined as the first direction X, and the horizontal direction that intersects the first direction X will be defined as the second direction Y, and the vertical direction that intersects the first direction X and the second direction Y is defined as the third direction Z. In this embodiment, the first direction X, the second direction Y, and the third direction Z are orthogonal to each other.

The batteries 6 are arranged such that the output terminals 12 face the same direction. The batteries 6 of the embodiment are arranged such that the output terminal 12 faces vertically upward. Further, the batteries 6 are arranged such that, when adjacent batteries 6 are connected in series, the anode terminal 11a of one of the batteries 6 and the cathode terminal 12b of the other battery 6 are adjacent to each other. Further, the batteries 6 are arranged such that, when adjacent batteries are connected in parallel, the anode terminal 12a of one of the batteries 6 and the anode terminal 12a of the other battery 6 are adjacent to each other.

A separator (not shown) is provided between two adjacent batteries 6. This insulates the two batteries 6 electrically. The separator is also referred to as an insulative spacer and is comprised of, for example, a resin sheet having insulative property. The resin forming the separator is exemplified by a resin such as polypropylene (PP), polybutylene terephthalate (PBT), polycarbonate (PC), and Noryl (registered trademark) resin (modified PPE), etc.

The plurality of batteries 6 are sandwiched by a pair of end plates (not shown) in the first direction X. The pair of end plates are adjacent to the batteries 6 located at the ends in the first direction X via a separator. Each end plate is a metal plate made of a metal such as iron, stainless steel, and aluminum. Further, the plurality of batteries 6 are bounded by a pair of binding members (not shown) in the first direction X. The pair of binding members are also referred to as bind bars and are members elongated in the first direction X. The pair of binding members are arranged in, for example, the second direction Y. Each binding member is made of a metal such as iron and stainless steel.

The plurality of batteries 6 and the plurality of separators are arranged alternately and, in that state, sandwiched by the pair of end plates in the first direction X. The pair of binding members are arranged to sandwich the plurality of batteries 6, the plurality of separators, and the pair of end plates in the second direction Y, and the ends of each binding member is fixed to the pair of end plates. For example, the binding member has, at the ends thereof in the first direction X, a bent part that overlaps the principal surface of the end plate, and the bent part is fixed to the end plate by a screw, etc. The separator, the end plate, and the binding member have a publicly known structure so that an illustration and a detailed description thereof will be omitted.

The output terminals 12 of adjacent batteries 6 are electrically connected by the bus bar 4. The bus bar 4 is a metal member having a substantially band shape. One end of the bus bar 4 is connected to the anode terminal 12a of one of the two adjacent batteries 6, and the other end is connected to the cathode terminal 12b of the other battery 6. The bus bar 4 may form a battery block by connecting the output terminals 12 in the plurality of adjacent batteries 6 having the same polarity in parallel and may further connect the battery blocks in series.

A duct plate (not shown) is mounted on the upper surface of the battery stack 2. The duct plate has a gas duct in which the valve part 14 of each battery 6 is connected. The gas discharged from each battery 6 flows into the gas duct. Further, the duct plate has an opening at a position that overlaps the output terminal 12 of each battery 6, and the bus bar 4 is mounted on each opening. The plurality of bus bars 4 are supported by the duct plate. Therefore, the duct plate also functions as a bus bar plate. Further, a voltage detection line is mounted on the duct plate.

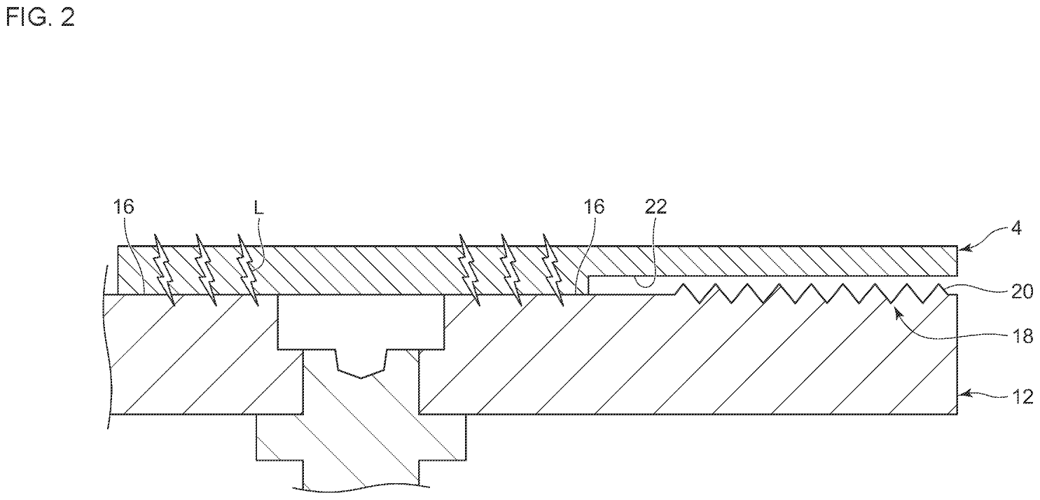

FIG. 2 is a cross-sectional view of a part of the output terminal 12 and the bus bar 4 included in the battery module 1 according to embodiment 1. The output terminal 12 includes a bonding surface 16 and a probe trace 18 on the surface that faces the bus bar 4. The bonding surface 16 is a surface of the output terminal 12 to which the bus bar 4 is bonded. The bus bar 4 is bonded to the output terminal 12 by, for example, laser welding while the bus bar 4 is in contact with the bonding surface 16. More specifically, the bus bar 4 is bonded to the bonding surface 16 as the position where the bonding surface 16 and the bus bar 4 overlap is irradiated with laser light L. The output terminal 12 and the bus bar 4 may be bonded by ultrasonic welding or arc welding.

The output terminal 12 and the bus bar 4 may each be made of a single metallic material or made of a clad material. Further, the output terminal 12 and the bus bar 4 may be made of the same type of metal or different types of metal.

The probe trace 18 is an irregularity formed as the probe of an apparatus for charging/discharging the battery 6 or conducting an inspection is pressed against the output terminal 12. The probe trace 18 is not limited to any particular shape and may be conical-shaped, pyramidal-shaped, ball-shaped, flat-shaped, crown-shaped, etc. The probe trace 18 has a plurality of convex parts 20 projecting with respect to the bonding surface 16 toward the bus bar 4. The height of the convex part 20 is not less than 50 μm and not more than 200 μm. The height of the convex part 20 is a distance from the bonding surface 16 to the apex of the convex part 20 in the direction in which the output terminal 12 and the bus bar 4 are stacked.

The bus bar 4 has a concave part 22 that faces the probe trace 18. The concave part 22 is provided to overlap the probe trace 18 as viewed in the direction in which the output terminal 12 and the bus bar 4 are stacked. The depth of the concave part 22 is equal to or larger than the height of the convex part 20. The depth of the concave part 22 is a distance from the surface in contact with the bonding surface 16 to the bottom surface of the concave part 22 in the direction in which the output terminal 12 and the bus bar 4 are stacked. The bus bar 4 of this embodiment includes one concave part 22 that overlaps the entirety of the probe trace 18.

When the bus bar 4 is mounted on the bonding surface 16 of the output terminal 12, the convex part 20 of the probe trace 18 is accommodated in the concave part 22. Ideally, the entirety of the convex part 20 is accommodated in the concave part 22. This inhibits the bus bar 4 from being lifted from the bonding surface 16 due to the interference between the convex part 20 and the bus bar 4. This places the bonding surface 16 to be in intimate contact with the bus bar 4 and so ensures that the output terminal 12 and the bus bar 4 are bonded more properly than otherwise.

As described above, the battery module 1 according to this embodiment includes the battery stack 2 in which the plurality of batteries 6 each including the output terminal 12 are arranged and the bus bar 4 bonded to the output terminal 12 of each battery 6 to electrically connect the plurality of batteries 6. The output terminal 12 has the probe trace 18 on the surface that faces the bus bar 4, and the bus bar 4 has the concave part 22 that faces the probe trace 18. By providing the concave part 22 in the bus bar 4, the probe trace 18 is inhibited from interfering with the bus bar 4 when the bus bar 4 is mounted on the output terminal 12.

This can increase the reliability of connection between the output terminal 12 and the bus bar 4. Therefore, the safety of the battery module 1 can be increased. Further, even when the position where the probe is pressed against the output terminal 12 is changed, interference between the probe trace 18 and the bus bar 4 can be easily inhibited merely by changing the position of the concave part 22 in the bus bar 4 in alignment with the position of the probe trace 18.

Further, the bus bar 4 of this embodiment has one concave part 22 that overlaps the entirety of the probe trace 18. This simplifies the shape of the bus bar 4 as compared with the case where a plurality of concave parts 22 are provided. It also inhibits the steps of manufacturing the bus bar 4 from becoming complicated and the cost from increasing due to the provision of of the concave part 22.

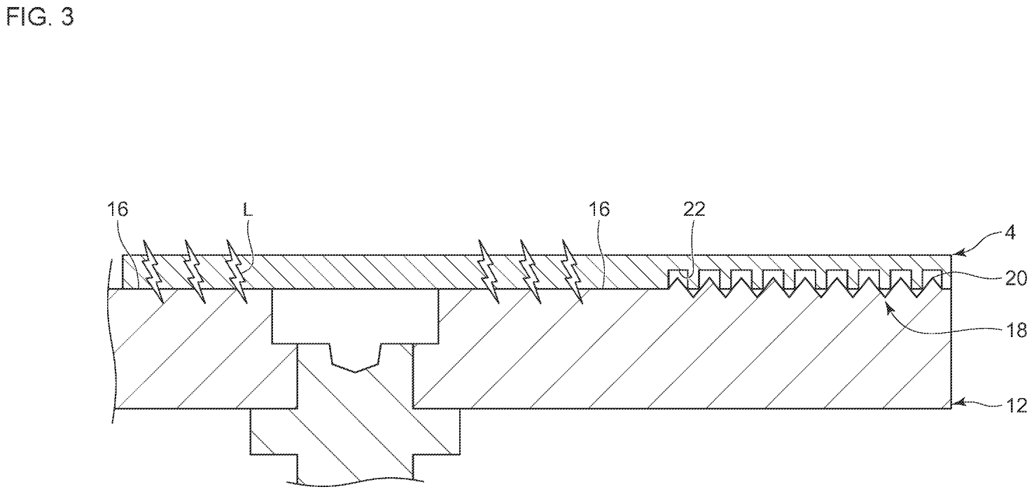

Variation 1 to the battery module 1 according to embodiment 1 is possible as described below. FIG. 3 is a cross-sectional view of a part of the output terminal 12 and the bus bar 4 included in the battery module 1 according to variation 1.

The bus bar 4 according to this variation includes a plurality of concave parts 22. Each of the plurality of concave parts 22 overlaps a portion of the probe trace 18. In each concave part 22, one or a plurality of convex parts 20 are accommodated. Such a configuration can also inhibit the probe trace 18 from interfering with the bus bar 4 when the bus bar 4 is mounted on the output terminal 12. Accordingly, the reliability of connection between the output terminal 12 and the bus bar 4 can be increased.

Further, the volume of the large-thickness part of the bus bar 4 can be increased as compared with the case of providing one concave part 22 that covers the entirety of the probe trace 18 so that the strength of the bus bar 4 can be increased. The region in the bus bar 4 where the plurality of concave parts 22 are arranged may be irradiated with laser light L. In this case, the region between adjacent concave parts 22 in the bus bar 4 is also bonded to the output terminal 12. Therefore, that region will also represent the bonding surface 16. This reduces the electric resistance between the output terminal 12 and the bus bar 4.

### Embodiment 2

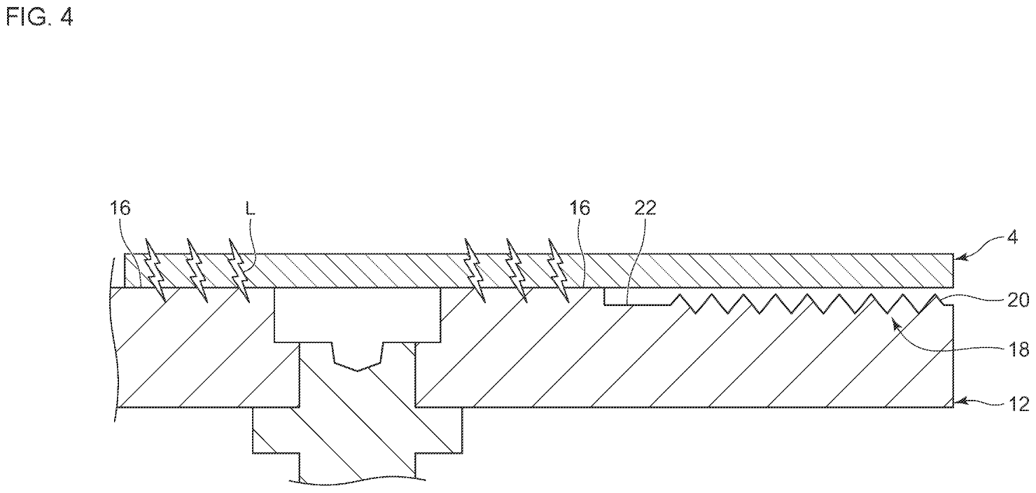

Embodiment 2 includes features common to those of embodiment 1 except for the structure of the bus bar 4 and the output terminal 12. The following description of this embodiment highlights features different from those of embodiment 1, and the description of the common features will be simplified or omitted. FIG. 4 is a cross-sectional view of a part of the output terminal 12 and the bus bar 4 included in the battery module 1 according to embodiment 2.

The battery module 1 according to this embodiment includes the battery stack 2 in which the plurality of batteries 6 each including the output terminal 12 are arranged and the bus bar 4 bonded to the output terminal 12 of each battery 6 to electrically connect the plurality of batteries 6.

The output terminal 12 according to this embodiment has the bonding surface 16, the concave part 22, and the probe trace 18. The bonding surface 16 is a surface to which the bus bar 4 is bonded. The concave part 22 is concave with respect to the bonding surface 16 in a direction away from the bus bar 4. The probe trace 18 is accommodated in the concave part 22. The probe trace 18 has a plurality of convex parts 20 projecting from the bottom surface of the concave part 22 toward the bus bar 4. The height of the convex part 20 is not less than 50 μm and not more than 200 μm. The depth of the concave part 22 is equal to or larger than the height of the convex part 20. The depth of the concave part 22 is a distance from the bonding surface 16 to the bottom surface of the concave part 22 in the direction in which the output terminal 12 and the bus bar 4 are stacked. The height of the convex part 20 is a distance from the bottom surface of the concave part 22 to the apex of the convex part 20 in the stack direction.

Thus, the probe trace 18 is inhibited from interfering with the bus bar 4 when the bus bar 4 is mounted on the output terminal 12 equally by providing the concave part 22 in the region of the output terminal 12 where the probe trace 18 is formed. This can increase the reliability of connection between the output terminal 12 and the bus bar 4.

Embodiments of the present disclosure have been described above in detail. The embodiments described above are merely specific examples of practicing the present disclosure. The details of the embodiments shall not be construed as limiting the technical scope of the present disclosure. A number of design modifications such as change, addition, deletion, etc. of constituting elements may be made to the extent that they do not depart from the idea of the disclosure defined by the claims. New embodiments with design modifications will provide the combined advantages of the embodiment and the variation. Although the details subject to such design modification are emphasized in the embodiments by using phrases such as “of this embodiment” and “in this embodiment”, details not referred to as such are also subject to design modification. Any combination of constituting elements included described above is also useful as an embodiment of the present disclosure. Hatching in the cross section in the drawings should not be construed as limiting the material of the hatched object.

The number of batteries 6 provided in the battery module 1 is not limited to any particular number. The structure of the parts of the battery stack 2, including the structure for binding the plurality of batteries 6, is not limited to any structure. The battery 6 may be cylindrically shaped.

### INDUSTRIAL APPLICABILITY

The present invention can be used in battery modules.

### REFERENCE SIGNS LIST

1 battery module, 2 battery stack, 4 bus bar, 6 battery, 12 output terminal, 16 bonding surface, 18 probe trace, 20 convex part, 22 concave part

1. A battery module comprising:
a battery stack in which a plurality of batteries each having an output terminal are arranged; and
a bus bar bonded to the output terminal of each battery and electrically connecting the plurality of batteries, wherein
the output terminal has a probe trace on a surface that faces the bus bar, and
the bus bar has a concave part that faces the probe trace.

2. The battery module according to claim 1, wherein
the bus bar has one concave part that overlaps the entirety of the probe trace.

3. The battery module according to claim 1, wherein
the bus bar includes a plurality of concave parts that overlap respectively different parts of the probe trace.

4. The battery module according to any one of claims 1 through 3, wherein
the probe trace has a convex part that projects with respect to a bonding surface of the output terminal to which the bus bar is bonded toward the bus bar, and
a height of the convex part is not less than 50 μm and not more than 200 μm.

5. A battery module comprising:
a battery stack in which a plurality of batteries each having an output terminal are arranged; and
a bus bar bonded to the output terminal of each battery and electrically connecting the plurality of batteries, wherein
the output terminal has a bonding surface bonded to the bus bar, a concave part concave with respect to the bonding surface in a direction away from the bus bar, and a probe trace accommodated in the concave part.
